(19) United States
(12) Patent Application Publication
(10) Pub. No.: US 2007/0049444 A1
(43) Pub. Date: Mar. 1, 2007

(54) Automatic vehicle gearshift transmission

(76) Inventors: Gerhard Gumpoltsberger, Friedrichshafen (DE); Matthias Reisch, Ravensburg (DE); Stefan Kilian, Friedrichshafen (DE)

Correspondence Address: DAVIS & BUJOLD, P.L.L.C., 112 PLEASANT STREET, CONCORD, NH, 03301, US

(21) Appl. No.: 11/510,887

(22) Filed: Aug. 28, 2006

(30) Foreign Application Priority Data
Aug. 29, 2005 (DE) 10 2005 040 769.2

(51) Int. Cl. F16H 3/72

(52) U.S. Cl. 475/5

(57) ABSTRACT

An automatic gearshift transmission with a drive input shaft and a drive output, a mechanical gearshift with first and second planetary gearsets, the first planetary gearset being a single planetary gearset downstream from which is connected a double planetary gearset, with several shift elements, including clutches and brakes and with an electric machine provided as a starter and/or generator and/or for the at least partial electric operation of a vehicle, such that the electric machine can be connected by way of a fourth clutch to the combustion engine and by way of a fifth clutch to a first shaft of the first planetary gearset. The combustion engine can be connected by way of the fourth and fifth clutches to the annular gear of the first planetary gearset and/or the electric machine can be connected by way of the fifth clutch to the annular gear of the first planetary gearset.

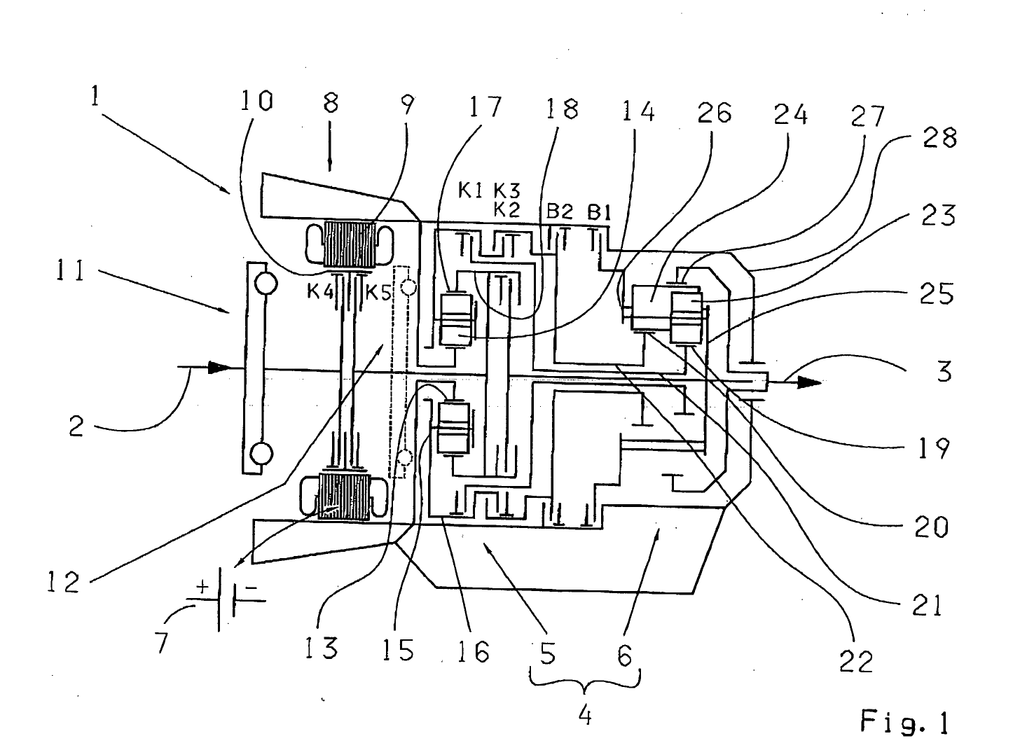

This application claims priority from German Application Serial No. 10 2005 040 769.2 filed Aug. 29, 2005.

### FIELD OF THE INVENTION

The invention concerns an automatic vehicle gearshift transmission.

### BACKGROUND OF THE INVENTION

From the generically similar DE 101 40 424 A1 a parallel-hybrid drive train of a motor vehicle is known. Besides the internal combustion engine this drive train comprises an automatic gearshift transmission which has two drive input shafts that can be connected to the combustion engine and a drive output shaft that can be coupled to at least one drive axle of the motor vehicle, as well as a mechanical gearshift with a first and a second planetary gearset, several clutches, several brakes and an electric machine. The electric machine can be operated as a starter/generator and/or for the continuously variable adjustment of the transmission and/or to drive the motor vehicle under electric power. If the driver so wishes, acceleration can take place in boost operation with a drive torque enhanced by the electric machine.

In the case of this known transmission, driving operation takes place in such manner that the vehicle can start from rest without a hydraulic converter, a solar gear of the first planetary gear stage being connectable to a starting brake via a solar gear shaft. Of the two clutches, one clutch co-operates with this solar gear shaft in such manner that when the starting brake has been released and the said one clutch has been engaged, the starter torque for starting up the internal combustion engine is transmitted to the first planetary gear stage via the solar gear shaft. Under certain circumstances, during this there may occur interruptions of the traction force in the drive train which, though slight, are nevertheless undesired as such.

From DE 199 17 665 A1 it is already known, in a hybrid drive concept having two electric machines, for the purpose of reducing the traction force interruption phase during purely electric driving operation by means of a first electric machine, to start the combustion engine by means of a second electric machine and then couple it into the drive train when the rotation speed difference between the combustion engine and the transmission input shaft is very small. However, this possible solution for the problem of traction force interruption requires the presence of two electric machines.

A drive train with an internal combustion engine and two electric drive aggregates is also known from another document, DE 103 19 880 A1. According to that invention an electric drive aggregate can be coupled with the solar gear of the planetary transmission by means of a clutch.

Accordingly, the purpose of the present invention is to improve a transmission of the type in question, to the effect that while using components known as such, fewer components are used, the arrangement for the starter and/or generator or recuperation function is simplified, and thereby the necessary structural space and costs are reduced.

### SUMMARY OF THE INVENTION

The objective set is achieved by an automatic vehicle gearshift transmission with a drive input shaft that can be connected to a combustion engine and a drive output shaft that can be connected to at least one vehicle axle, a mechanical gearshift with a first and a second planetary gearset, the first planetary gearset being a single planetary gearset with a double planetary gearset, for example a Ravigneaux gearset, connected downstream therefrom. In addition there are provided several shift elements and brakes, and an electric machine which is provided as a starter and/or generator and/or for the at least partial driving of a vehicle under electric power, and the electric machine can be connected via a first clutch to the combustion engine and via a second clutch to a first shaft of the first planetary gearset. According to the invention, the combustion engine can be connected via the first and second clutch to the annular gear wheel of the first planetary gearset and/or the electric machine can be connected via the second clutch to the annular gear wheel of the first planetary gearset.

Advantageously, the transmission according to the invention saves components compared with the closest prior art. For example, a starting brake previously provided on the input side is not needed here. Furthermore, instead of the previously used two input shafts in the transmission, only one input shaft is needed. Thanks to this the transmission can advantageously be designed such that both the combustion engine and also the electric machine can be connected via two clutches or via one clutch to the annular gear of the first planetary gearset. This on the one hand gives a transmission with a simplified starter and/or generator and recuperation capacity or one with simpler boost operation, and on the other hand distinctly reduces the structural space occupied by the transmission and cuts its production costs.

Likewise advantageously, at least one of the two shift elements can be made as a disk clutch and the shift elements can be actuated or controlled independently of one another.

Alternatively, depending on the application situation in each case, it can also be advantageous to make the clutches such that they engage with positive locking, again with the two shift elements being actuated independently of one another.

It is also proposed that one of the two shift elements is made as a freewheel element, or that a further shift element is provided and this is made as a freewheel element. This makes it possible for example to have an emergency running function.

In a preferred embodiment, for example the shift elements and/or the electric machine is/are arranged coaxially with the input shaft.

Alternatively, the electric machine can be arranged with its axis parallel to the input shaft, such that the drive from or to the input shaft takes place via a gear stage or a chain or belt drive.

Advantageously, in one embodiment the shift elements are arranged radially inside the electric machine and also radially one inside the other.

In a further development it is proposed to mount the shift elements axially next to one another, so achieving a particularly preferred space-saving structure of the transmission.

As a particularly simple and therefore inexpensive structure of the vehicle transmission, the solar gear is arranged fixed to the housing.

Advantageously, the first planetary gearset is connected to the second planetary gearset by means of various clutches via the web and/or the annular gear of the first planetary gearset.

For example, the web of the first planetary gearset is connected with the first solar gear of the second planetary gearset by a first clutch and/or with the second solar gear of the second planetary gearset by a second clutch.

The annular gear of the first planetary gearset can be connected with the web of the second planetary gearset by a further clutch.

Optionally, the combustion engine and/or the electric machine can also be connected with the second planetary gearset by the actuation of clutches.

Advantageously, at least one torsion damper is provided between the combustion engine and the electric machine and/or at least one torsion damper is provided between the electric machine and the transmission, in particular between the electric machine and the first planetary gearset.

### BRIEF DESCRIPTION OF THE DRAWING

The invention will now be described, by way of example, with reference to the accompanying drawing in which:

The single FIGURE shows a schematic cross-section of a transmission according to the invention.

### DETAILED DESCRIPTION OF THE INVENTION

An automatic vehicle gearshift transmission 1 is part of a parallel-hybrid drive train of a motor vehicle, no more of which is shown. This transmission 1 comprises a drive input shaft 2 connected on the input side, for example via a torsion damper 11, to an internal combustion engine of the drive train (not shown).

On the output side, a drive output shaft 3 is provided on the transmission 1, which can be connected to at least one vehicle axle in order to transmit a drive torque. Between the two said shafts 2 and 3 is arranged a mechanical gearshift 4 consisting of a first transmission stage (first planetary gearset 5) and a second transmission stage (second planetary gearset 6), several clutches K1, K2, K3 and two brakes B1 and B2.

The first transmission stage consists for example of a single planetary gearset 5 arranged upstream from a second transmission stage consisting of a Ravigneaux gearset 6. Such an arrangement enables for example a range-change automatic transmission with six forward speeds and one reverse speed.

A solar gear 13 of the first planetary gearset 5 is in rotationally fixed connection with the housing 28 of the vehicle transmission 1 via a solar gear shaft. The planetary gear wheels 14 of the first planetary gearset 5 can be connected with the second planetary gearset 6 via the planetary carrier 15 and via clutches K1, K3, which engage with the web shaft 16. On the drive input side the annular gear 17 of the first planetary gearset 5 can be connected with the drive input shaft 2 via an annular gear shaft 18 and via clutches K4, K5. On the drive output side the annular gear 17 can be connected with the second planetary gearset 6 via the annular gear shaft 18 and a clutch K2.

The second, double planetary gearset 6 consists essentially of a first solar gear 19 and a second solar gear 20, which can be connected with the first planetary gearset 5 via a first solar gear shaft 21 and via a second solar gear shaft 22 and via clutches K1, K3. The second solar gear shaft 22 can be locked relative to the housing 28 by means of the brake B2.

A set of first planetary gears 23 is mounted to rotate on a first planetary carrier 25 and a set of second planetary gears 24 is mounted to rotate on a second planetary carrier 26, and the planetary carrier 26 can be locked relative to the housing 28 by means of the brake B1. An annular gear 27 of the second planetary gearset 6 is connected directly to the drive output shaft 3 of the vehicle transmission 1.

In addition, between the combustion engine and the gearshift transmission 4 there is arranged an electric machine 8, which consists essentially of an external stator 9 and an internal rotor 10. The electric machine 8 is made as a starter and/or generator, and the electric machine 8 is thus also associated with an electronic control system (not shown) and an energy accumulator 7.

Radially inside the electric machine 14 are arranged two clutches K4 and K5, which enable on the one hand a connection to the drive input shaft 2 and on the other hand to the annular gear shaft 18 of the first planetary gearset 5 and a connection to the rotor 10 of the electric machine 8 (for the sake of simplicity, the two clutches K4 and K5 are earlier also referred to as the first and second clutches).

Thus, by virtue of the combination of the gearshift transmission 4 with the electric machine 8, the vehicle so equipped can start off under electric motor power. Furthermore, during driving operation and in particular during braking operation of the vehicle, energy recuperation can be effected by the electric machine 8, since electrical energy can be intermediately stored in the symbolically represented energy accumulator 7.

With a vehicle transmission of this type the vehicle can be driven purely electrically both forward and in reverse, for example in inner cities or other areas where emission-free operation is desired.

Thanks to the use of the two clutches K4 and K5 in accordance with the invention, the electric machine 8 can be connected directly to the drive input shaft 2 by way of the clutch K4 for starting up the combustion engine. The drive input shaft 2, in turn, is in direct drive connection with the crankshaft of the combustion engine. Thereby, the known advantages of the vehicle transmission 1 described earlier with a mechanical gearshift transmission 4 and an electric machine 8, namely to enable a driver who so wishes to reinforce the drive torque so that unrestricted boost operation is possible, are supplemented by the advantage that starting can be carried out comfortably and without any detectable traction force interruption.

Advantageously, for example the clutch K5 is made as a starting clutch, so that the vehicle equipped with the said transmission 1 can start without a hydrodynamic converter.

Furthermore, an arrangement of this type enables the vehicle's electrical system to be supplied continuously when the electric machine 8 is operating in generator mode.

Depending on the intended use, the torsion dampers 11, 12 can advantageously be arranged in the force-flow direction both before the electric machine 8, i.e., between the combustion engine and the clutches K4 and K5, and after the electric machine 9, i.e. between the clutches K4 and K5 and the speed-shift transmission 4. The torsion dampers 11, 12 can be made both as single-action and as dual-action torsion dampers.

Reference Numerals 1 vehicle transmission 2 drive input shaft 3 drive output shaft 4 gearshift 5 first planetary gearset 6 second planetary gearset 7 energy accumulator 8 electric machine 9 stator 10 rotor 11, 12 torsion dampers 13 solar gear 14 planetary gears 15 web, planetary carrier 16 web shaft 17 annular gear 18 annular gear shaft 19 first solar gear 20 second solar gear 21 first solar gear shaft 22 second solar gear shaft 23 first planetary gears 24 second planetary gears 25 first web, planetary carrier 26 second web, planetary carrier 27 annular gear 28 housing K1 first clutch K2 second clutch K3 third clutch K4 fourth clutch K5 fifth clutch B1 first brake B2 second brake

1-17. (canceled)

18. An automatic vehicle gearshift transmission (1) comprising a drive input shaft (2) connected to an internal combustion engine, a drive output shaft (3) connected to at least one vehicle axle, a mechanical gearshift (4) with a first planetary gearset (5) and a double planetary gearset (6), the first planetary gearset (5) being a single planetary gearset and the double planetary gearset (6) being connected downstream thereof, the mechanical gearshift (4) having several shift elements comprising at least first, second and third clutches and at least one brake (K1, K2, K3; B1, B2), an electric machine (8) being provided as at one of a starter, a generator and at least partial electric operation of a vehicle, such that the electric machine (8) is releasably connected to the combustion engine by a fourth clutch (K4), and by a fifth clutch (K5) to a first shaft of the first planetary gearset (5), the combustion engine is at least one of releasably connected by the fourth and the fifth clutches (K4, K5) to an annular gear of the first planetary gearset (5) and the electric machine (8) is releasably connected by the fifth clutch (K5) to the annular gear of the first planetary gearset (5).

19. The automatic vehicle gearshift transmission (1) according to claim 18, wherein at least one of the fourth and the fifth clutches (K4, K5) is a disk clutch and the fourth and the fifth clutches (K4, K5) are independently actuated and controlled.

20. The automatic vehicle gearshift transmission (1) according to claim 18, wherein at least one of the fourth and the fifth clutches (K4, K5) is made as a positive-locking clutch and at least one of the fourth and the fifth clutches (K4, K5) can be independently actuated and controlled.

21. The automatic vehicle gearshift transmission (1) according to claim 18, wherein at least one of the fourth and the fifth clutches (K4, K5) is one of a freewheel element or a further shift element is provided which is a freewheel element.

22. The automatic vehicle gearshift transmission (1) according to claim 18, wherein at least one of the fourth and the fifth clutches (K4, K5) is arranged coaxially with the input shaft (2).

23. The automatic vehicle gearshift transmission (1) according to claim 18, wherein the electric machine (8) is arranged coaxially with the input shaft (2).

24. The automatic vehicle gearshift transmission (1) according to claim 18, wherein an axis of the electric machine (8) is parallel to the input shaft (2).

25. The automatic vehicle gearshift transmission (1) according to claim 24, wherein the electric machine (8) is connected to the input shaft (2) via one of a gear stage, a chain drive and a belt drive.

26. The automatic vehicle gearshift transmission (1) according to claim 22, wherein the fourth and the fifth clutches (K4, K5) are arranged radially inside the electric machine (8).

27. The automatic vehicle gearshift transmission (1) according to claim 18, wherein the fourth and the fifth clutches (K4, K5) are arranged directly axially adjacent to one another.

28. The automatic vehicle gearshift transmission (1) according to claim 18, wherein the fourth and the fifth clutches (K4, K5) are arranged radially one inside the other.

29. The automatic vehicle gearshift transmission (1) according to claim 18, wherein a sun gear (13) of the first planetary gearset (5) is fixed to a housing of the transmission.

30. The automatic vehicle gearshift transmission (1) according to claim 18, wherein at least one of a web (15) and an annular gear (17) of the first planetary gearset (5) is connected to the second planetary gearset (6).

31. The automatic vehicle gearshift transmission (1) according to claim 18, wherein a web (15) of the first planetary gearset (5) is connected to one or more of a first and a second sun gear (19, 20) of the second planetary gearset (6).

32. The automatic vehicle gearshift transmission (1) according to claim 18, wherein an annular gear (17) of the first planetary gearset (5) is connected to a web (25) of the second planetary gearset (6).

33. The automatic vehicle gearshift transmission (1) according to claim 18, wherein at least one of the combustion engine and the electric machine (8) is directly connected to the second planetary gearset (6).

34. The automatic vehicle gearshift transmission (1) according to claim 18, wherein at least one torsion damper (11) is provided between the combustion engine and the electric machine (8) and at least one torsion damper (12) is provided between the electric machine (8) and the first planetary gearset (5).
